(19) United States
(12) Patent Application Publication
(10) Pub. No.: US 2023/0365749 A1
(43) Pub. Date: Nov. 16, 2023

(54) NOVEL ANTIFOAMING AGENTS

(71) Applicants: PMC OUVRIE, CARVIN (FR); UNIVERSITE CLAUDE BERNARD LYON 1, VILLEURBANNE (FR); CENTRE NATIONAL DE LA RECHERCHE SCIENTIFIQUE (CNRS), PARIS (FR); ECOLE SUPERIEURE DE CHIMIE PHYSIQUE ELECTRONIQUE DE LYON, VILLEURBANNE CEDEX (FR)

(72) Inventors: Romain CHAVALLARD, VILLEURBANNE (FR); Catherine GROUX-HENRY, FRONTENAS (FR); Marc LEMAIRE, VILLEURBANNE (FR); Philippe MAKIEWICZ, MERICOURT (FR); Estelle METAY, COMMUNAY (FR)

(21) Appl. No.: 18/246,440

(22) PCT Filed: Oct. 4, 2021
(86) PCT No.: PCT/EP2021/077278

§ 371 Date: Mar. 23, 2023

(30) Foreign Application Priority Data
Oct. 5, 2020 (EP) 20306157.7

(51) Int. Cl. C08G 65/26; C08G 65/18

(52) U.S. Cl. CPC C08G 65/2696; C08G 65/18

(57) ABSTRACT

The invention relates to the use of a polymer P as antifoaming agent, the polymer P being a linear polymer prepared by polymerization of monomer chosen from monomer M1, monomer M2, or monomer M1 and monomer M2 monomer M1 having the following formula (I): wherein R¹ and R², independently of each other, is chosen from: —a benzyl, —a (C₁-C₁₂)alkyl group optionally substituted by a —O—(C₁-C₁₂)alkyl group, and —a (C₃-C₁₂)cycloalkyl group optionally substituted by a —O—(C₁-C₁₂)alkyl group, monomer M2 having the following formula (II): wherein R4 represents: a (C₁-C₁₂)alkyl group or a —CH₂—O—R⁵ group, wherein R⁵ is chosen from: a benzyl, a (C₁-C₁₂)alkyl group optionally substituted by a —O(C₁-C₁₂)alkyl, and a (C₃-C₁₂)cycloalkyl group optionally substituted by a —O—(C₁-C₁₂)alkyl group, R³ represents a (C₁-C₁₂)alkyl group, or R³ and R⁴ form together, with the carbon atom bearing them, a ((C₃-C₁₂)cycloalkyl group.

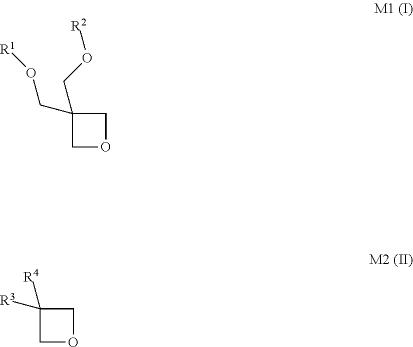

### FIELD OF THE INVENTION

The present invention deals with the use of a linear polymer P prepared by polymerization of one or more oxetane monomer(s) M1 and/or M2 as antifoaming agents. It also relates to an antifoam composition comprising such a polymer. The present invention deals with a polymer P′ with antifoam properties and prepared by polymerization of oxetane monomers M1 and M2 and it deals with a method for manufacturing such a polymer P′.

### BACKGROUND OF THE INVENTION

Antifoaming agents, also known as antifoam agents or defoamers, are chemical additives which reduce the formation or the presence of foam. They can either eliminate existing foam or prevent formation of foam or do both. They are used in many fields, notably in building and construction, wood pulp and paper industry, wastewater treatment, food industry, industries of biotechnologies or cosmetics.

Antifoaming agents can be hydrophobic solids dispersed in carrier oil, aqueous suspensions/emulsions, liquid single components or solids.

Antifoaming agents can be polymers such as silicone polymers or polyethylene glycol/polypropylene glycol (PEG-PPG) copolymers. Alkyl polyacrylate can also be used as antifoaming agent.

In an effort to discover new antifoaming agents with satisfying properties, a new kind of polyether polymers were found.

In particular, such polyether polymers may be based on raw material from the biomass and not from petrochemicals. Nowadays, reducing consumption of petrochemicals is an important challenge. It is known that PEG-PPG copolymers are manufactured from petrochemicals. Using raw materials from the biomass is then a relevant alternative.

It was found notably that pentaerythritol and trimethylolpropane, produced through Canizzaro condensation of acetaldehyde with formaldehyde, and butanal with formaldehyde respectively, can be used to manufacture polyether polymers according to the invention and lead to bio-sourced polymers with interesting antifoaming properties.

### SUMMARY OF THE INVENTION

The present invention deals with the use of a polymer P as antifoaming agent, the polymer P being a linear polymer prepared by polymerization of monomer chosen from monomer M1, monomer M2, or monomer M1 and monomer M2
monomer M1 having the following formula (I):

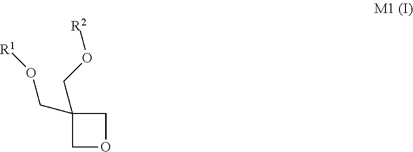

wherein
R¹ and R², independently of each other, is chosen from
   a benzyl,
   a (C₁-C₁₂)alkyl group optionally substituted by a —O—(C₁-C₁₂)alkyl group, and
   a (C₃-C₁₂)cycloalkyl group optionally substituted by a —O—(C₁-C₁₂)alkyl group,
and monomer M2 having the following formula (11):

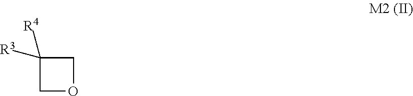

wherein
R⁴ represents
   a (C₁-C₁₂)alkyl group or
   a —CH₂—O—R⁵ group, wherein R⁵ is chosen from
   a benzyl,
   a (C₁-C₁₂)alkyl group optionally substituted by a —O(C₁-C₁₂)alkyl, and
   a (C₃-C₁₂)cycloalkyl group optionally substituted by a —O—(C₁-C₁₂)alkyl group,
R³ represents a (C₁-C₁₂)alkyl group,
or R³ and R⁴ form together, with the carbon atom bearing them, a (C₃-C₁₂)cycloalkyl group.

The polymer is P is prepared by polymerization of:
one or several monomer M1; or
one or several monomer M2; or
one or several monomer M1 and one or several monomer M2.

Polymer P is a homopolymer or a copolymer. The copolymer can be a block copolymer or a statistic copolymer.

Advantageously, R¹ and R², independently of each other, represent a (C₁-C₁₂)alkyl group optionally substituted by a —O—(C₁-C₁₂)alkyl group.

Advantageously, monomer M2 is a monomer of formula M2′ as follows:

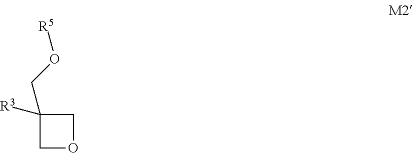

wherein
R⁵ is chosen from
   a benzyl,
   a (C₁-C₁₂)alkyl group optionally substituted by a —O(C₁-C₁₂)alkyl, and
   a (C₃-C₁₂)cycloalkyl group optionally substituted by a —O—(C₁-C₁₂)alkyl group,
R³ is as described previously.

Advantageously, R⁴ represents a group —CH₂—O—R⁵ and R¹, R², R³ and R⁵ represent, independently of each other, a (C₁-C₄)alkyl group.

Advantageously, polymer P is chosen from a diblock copolymer with a structure B1-B2, a diblock copolymer with a structure B2-B1, a triblock copolymer with a structure B1-B2-B1 and a triblock copolymer with a structure B2-B1-B2, block B1 being prepared by polymerization of monomer M1 and block B2 being prepared by polymerization of monomer M2.
B1 is advantageously prepared by polymerization of one monomer M1. Advantageously M1 is the sole monomer used for preparing block B1.
B2 is advantageously prepared by polymerization of one monomer M2. Advantageously M2 is the sole monomer used for preparing block B2.

Advantageously, polymer P is a statistic copolymer prepared by polymerization of a sole monomer M1 and a sole monomer M2.

Advantageously, the polymer P has a number average molar mass Mn comprised from 400 g/mol to 30 000 g/mol.

Advantageously, the polymer P has a degree of polymerization DP comprised from 2 to 220.

Advantageously, the polymer P has a polydispersity index PDI comprised from 1 to 3, preferably from 1.0 to 1.5.

Advantageously, the polymer P has a general formula (III):

R^{x}—O-[CU]-R^{y} (III)

wherein notation [CU] represents the constitutive units obtained by polymerization of monomer chosen from monomer M1, monomer M2, or monomer M1 and monomer M2, [CU] can further comprise at least one divalent group —R^{DG}—, linking two constitutive units, wherein R^{DG} is a (C₁-C₁₂)alkylene group.
R^{x} is chosen from
   a hydrogen atom,
   a —CO—(C₁-C₂₀)alkyl group optionally substituted by at least one group —R^{z}, wherein R^{z} is chosen from
      a hydroxyl group (OH),
      a —O—(C₁-C₁₂)alkyl group,
      an aliphatic 5- or 6-membered heterocycle, and
      an aliphatic 5- or 6-membered carbocycle
   a phenyl,
   a benzyl,
   a (C₁-C₂₀)alkyl group optionally substituted by at least one group —R^{z}, wherein R^{z} is as defined above.
R^{v} is chosen from:
   a hydrogen atom,
   a —CO—(C₁-C₂₀)alkyl group optionally substituted by at least one group R^{v} and
   a (C₁-C₂₀)alkyl group optionally substituted by at least one group R^{v}, wherein R^{v} is chosen from
      a hydroxyl group (OH),
      a —O—(C₁-C₁₂)alkyl group,
      a phenyl,
      a benzyl,
      an aliphatic 5- or 6-membered heterocycle and
      an aliphatic 5- or 6-membered carbocycle,
   a halogen atom chosen from Cl, Br and F,
   —SO₃H
   —NH₂ or —NH—(C₁-C₆)alkyl group.

Advantageously, R^{x} and R^{v} are each a hydrogen atom.

Advantageously, R^{x} is chosen from:
a —CO—(C₁-C₂₀)alkyl group optionally substituted by at least one group —R^{z}, wherein R^{z} is as defined previously, and
a (C₁-C₂₀)alkyl group optionally substituted by at least one group —R^{z}, wherein R^{z} is as defined previously.

The invention is also directed to an antifoam composition, under the form of an emulsion, comprising a polymer P as described above and below.

Advantageously, the antifoam composition comprises in wt. % compared to the total weight of the antifoam composition:
from 0.01 to 100 of the polymer P,
from 0 to 99.99 of a substance chosen among stabilator, emulsifier, antioxidant agent, preservative, thickener, and mixture thereof,
   the remaining, if any, being water.

The invention is also directed to a polymer P′, wherein polymer P′ is prepared by copolymerization of monomer M1 and monomer M2, M1 and M2 being as defined above and below, and wherein the number average molar mass Mn of polymer P′ is comprised from 400 g/mol to 30 000 g/mol. Polymer P′ is not prepared by copolymerization of monomer M1, monomer M2 and THF. In particular, polymer P′ is only prepared by copolymerization of monomer M1 and monomer M2.

The invention is also directed to a process for manufacturing a polymer P′ comprising the steps of:
(a1) mixing a catalyst and an initiator chosen from an initiator of formula R^{x}OH, wherein R^{x} is as defined previously, or an oxetane,
(b1 and c1) adding to the mixture obtained after step (a1) monomer M1 and monomer M2,
(d) then, adding a terminating agent.

### Definitions

In the present invention, a “hydrocarbon group” is a group consisting of C atoms and H atoms. The term “saturated” means in the present invention that the group does not contain double or triple bonds.

The term “unsaturated” means in the present invention that the group comprises one or several double bonds or triple bonds, preferably double bonds.

In the present invention, a “(Cₓ-C_{y})alkyl” group is understood to be a monovalent saturated, linear or branched hydrocarbon group containing x to y, carbon atoms. Thus, a (C₁-C₂₀)alkyl group contains 1 to 20 carbon atoms. Examples of such groups are methyl, ethyl, n-propyl, isopropyl, n-butyl, isobutyl, sec-butyl, tert-butyl, n-pentyl, sec-amyl, tert-amyl, n-hexyl, heptyl, octyl, nonyl, decyl, undecyl, dodecyl.

The term “(C₃-C₁₂)cycloalkyl”, as used in the present invention, refers to a monovalent hydrocarbon ring having 3 to 12 carbon atoms including, but not limited to, cyclopropyl, cyclopentyl, cyclohexyl and the like.

In the present invention “—O—(Cₓ-C_{y})alkyl” group is an alkoxy group. The (Cₓ-C_{y})alkyl group is as defined above and linked by an atom of oxygen to the rest of the molecule. Examples of such groups are methoxy, ethoxy, n-propoxy, isopropoxy, n-butoxy, tert-butoxy.

In the present invention “—CO—(Cₓ-C_{y})alkyl” group is an acyl group. The (Cₓ-C_{y})alkyl group is as defined above and is linked by a carbonyl group (CO) to the rest of the molecule. Examples of such groups are acetyl, propanoyl, butanoyl.

The term “aliphatic 5- or 6-membered carbocycle” as used in the present invention refers to a saturated or unsaturated but not aromatic, preferably saturated, hydrocarbon cycle, said cycle comprising 5 or 6 carbon atoms. It can be a cyclopentyl, cyclohexyl, cyclohexenyl or the like.

The term “aliphatic 5- or 6-membered heterocycle” as used in the present invention refers to an aliphatic 5- or 6-membered carbocycle as defined above in which one or several, preferably one or two, notably one, carbon atoms are each replaced independently by a heteroatom selected from O, S and N, preferably from O and N. It can be a tetrahydrofurane.

In the present invention, a “(Cₓ-C_{y})alkylene” group is understood to be a divalent saturated, linear or branched hydrocarbon group containing x to y, carbon atoms. Thus, a (C₁-C₂₀)alkylene group contains 1 to 20 carbon atoms. Examples of such groups are methylene, ethylene, propylene, butylene, pentylene, hexylene, heptylene, octylene.

The term “statistic copolymer” as used in the present invention refers to a random copolymer, in which in which the sequential distribution of the constitutive units obeys statistical laws.

The term “block copolymer” as used in the present invention refers to a copolymer formed when the two monomers cluster together and form ‘blocks’ of constitutive units.

### Use of Polymer P

The present invention relates to the use of a polymer P as described above and below as antifoaming agent.

Excessive foam occurs serious problems for processing of goods. An abundance of foam can reduce equipment capacity, increase manufacturing times, decrease product quality and impact safety. This is the reason why the invention is directed to produce defoamers and anti-foaming agents that reduce and hinder the formation of foam in industrial process.

In the present description, “antifoaming agent” and “defoamer” will be used interchangeably. The present invention relates to a method comprising adding a polymer P as described above and below for reducing foam formation. In particular, polymer P is added in a liquid or viscous composition for reducing foam formation. More particularly, polymer P is added in a composition comprising metal working fluids, engine oils, lubricants, hydraulic fluids, paints coatings, inks, compositions for paper industry, jet dyeing of textiles, leather processing, chemical processing for reducing foam formation.

An antifoaming agent can also be called an antifoam agent or a defoamer.

There are two kinds of antifoaming agents. The first kind is added to a liquid before foaming and prevents foaming, the second kind is added to a liquid after foaming and reduces the volume of foam.

In particular, polymer P is used to reduce the volume of foam.

More particularly, polymer P reduces the volume of foam by at least 20 vol %, preferably by at least 50 vol. %, more preferably by at least 70 vol %, relative to the total initial volume of foam. Thus, the present invention also relates to a method comprising adding a polymer P as described above and below in a foaming liquid or viscous composition for reducing the volume of foam. The liquid or viscous composition can be of any type, such as an aqueous or non-aqueous solution or an dispersion or an water-in-oil emulsion or an oil-in-water emulsion.

The liquid or viscous composition comprises component selected from water, natural fats, hydrocarbons, organic/inorganic charges, silicones, and mixtures thereof preferably in a content above 30% by weight, more preferably above 50% by weight, compared to the total weight of the composition.

In particular, the antifoaming agent is used in food industry, building and construction, industrial biotechnology, wastewater treatment, pulp and paper, and other industrial applications.

Specifically, food industry can be sugar refineries and distilleries, processing of potato and starch, extraction of proteins, vegetable processing and agro-food.

During beet processing foam occurs due to foam active substances as non-sugar ingredients and amines. By reducing foaming commonly encountered in sugar production and commercial distillation, plant downtimes can be minimized.

For building and construction, the polymer of the invention can be used to reduce foaming formation in mortars, gypsum and plaster. the polymer of the invention can reduce foam air entrapment.

Amino acid production by micro-organisms causes considerable foaming. Vitamin's production by biotechnology generates a compact foam. The polymer P of the invention can help to stabilize the process and reducing foam issues.

The polymer P of the invention can also be used to minimize foaming throughout the papermaking process, from preparation of pulp to the treatment of waste water passing through machinery and coating application processes. The polymer P of the invention can also be used to achieve optimal manufacturing conditions and improved product quality in all stages of the wood to paper process, including pulping, paper making, paper coating and recycling.

The polymer P of the invention can also be used to control foam and entrained air in wastewater systems. The polymer P can collapse and break down existing foam.

The causes of foam in a wastewater treatment plant are varied. In secondary treatment systems, foam is normally caused by biological activity. It can also result from mechanical action, chemical contamination, surfactants in the influent or some polymer treatments. Apart from the cause, foaming in secondary treatment and final effluent areas can lead to environmental, health and safety issues.

The polymer P of the invention can also be used for treatment of paint booths.

The polymer P of the invention can also be used as a defoamer for coatings, adhesives and sealants, as a defoamer for detergents, as a defoamer for leather and textiles, as a defoamer for metalworking, as a defoamer for mining and drilling, as a defoamer for personal care and cosmetics, as a defoamer for polymerization.

### Polymer P

Polymer P is a linear polymer prepared by polymerization of monomer chosen from the group comprising monomer M1, monomer M2 and combinations thereof. Polymer P can be a homopolymer. Polymer P can be a polymer composed of one or several blocks, these blocks being prepared by polymerization of monomer M1 or monomer M2. Polymer P can be a statistic copolymer.

Monomer M1 is of the following formula (I):

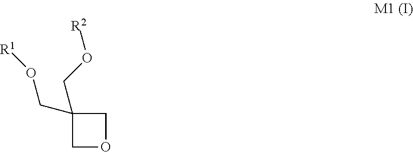

wherein
R¹ and R², independently of each other, is chosen from
   a benzyl,
   a (C₁-C₁₂)alkyl group optionally substituted by a —O—(C₁-C₁₂)alkyl group, and
   a (C₃-C₁₂)cycloalkyl group optionally substituted by a —O—(C₁-C₁₂)alkyl group.
R¹ and R² can be different or identical. In particular, R¹ and R² are identical.
Preferably, at least one of R¹ and R², independently of each other, is chosen from benzyl.
Preferably, both of R¹ and R² are benzyl.
Preferably, R¹ and R², independently of each other, is chosen from
   a (C₁-C₁₂)alkyl group not substituted or substituted by a —O—(C₁-C₁₂)alkyl group, preferably by a —O—(C₁-C₆)alkyl group, more preferably by a —O—(C₁-C₄)alkyl group, and
   a (C₃-C₁₂)cycloalkyl group not substituted or substituted by a —O—(C₁-C₁₂)alkyl group, preferably by a —O—(C₁-C₆)alkyl group, more preferably by a —O—(C₁-C₄)alkyl group.
Preferably, at least one of R¹ and R², independently of each other, is chosen from a (C₁-C₁₂)alkyl group not substituted or substituted as disclosed above, more preferably a (C₁-C₅)alkyl group not substituted or substituted as disclosed above, even more preferably a (C₁-C₆)alkyl group not substituted or substituted as disclosed above, more preferably a (C₁-C₄)alkyl group not substituted or substituted as disclosed above, even more preferably a (C₁-C₂)alkyl group not substituted or substituted as disclosed above. For example, at least one of R¹ and R², independently of each other, represents a (C₁-C₆)alkyl group substituted by a O—(C₁-C₆)alkyl group. For example, at least one of R¹ and R², independently of each other, represents a (C₁-C₄)alkyl group substituted by a O—(C₁-C₄)alkyl group.
Preferably, R¹ and R², independently of each other, are both chosen from a (C₁-C₁₂)alkyl group as disclosed above. Preferably R¹ and R² are identical. Preferably, R¹ and R² are each a methyl.
Preferably, at least one of R¹ and R², independently of each other, represents a (C₃-C₁₂)cycloalkyl group not substituted or substituted as disclosed above, more preferably a (C₅-C₆)cycloalkyl group not substituted or substituted as disclosed above. For example, at least one of R¹ and R², independently of each other, represents a (C₅-C₆)cycloalkyl group substituted by a —O—(C₁-C₆)alkyl group. For example, at least one of R¹ and R², independently of each other, represent a (C₅-C₆)cycloalkyl group substituted by a —O—(C₁-C₄)alkyl group.
Preferably, R¹ and R², independently of each other, are both chosen from a (C₃-C₁₂)cycloalkyl group as disclosed above. Preferably R¹ and R² are identical.
Preferably, R¹ and R², independently of each other, is chosen from a (C₁-C₁₂)alkyl group optionally substituted as disclosed above.

Monomer M2 is the following formula (II):

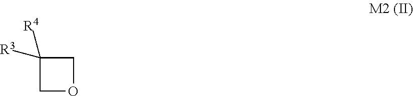

wherein
R⁴ represents:
   a (C₁-C₁₂)alkyl group or,
   a —CH₂—O—R⁵ group, wherein R⁵ is chosen from:
      a benzyl,
      a (C₁-C₁₂)alkyl group optionally substituted by a —O(C₁-C₁₂)alkyl, and
      a (C₃-C₁₂)cycloalkyl group optionally substituted by a —O—(C₁-C₁₂)alkyl group,
R³ represents a (C₁-C₁₂)alkyl group,
or R³ and R⁴ form together, with the carbon atom bearing them, a (C₃-C₁₂)cycloalkyl group.
R³ and R⁴ can be different or identical. In particular, R³ and R⁴ are different. Alternatively, R³ and R⁴ are identical.
In an embodiment, R³ and R⁴ form together, with the carbon atom bearing them, a cyclic (C₃-C₁₂)alkyl group, preferably a cyclic (C₄-C₆)alkyl group.
In another embodiment, R⁴ represents:
   a (C₁-C₁₂)alkyl group or
   a —CH₂—O—R⁵ group, wherein R⁵ is chosen from:
      a benzyl,
      a (C₁-C₁₂)alkyl group optionally substituted by a —O(C₁-C₁₂)alkyl, and
      a (C₃-C₁₂)cycloalkyl group optionally substituted by a —O—(C₁-C₁₂)alkyl group, and R³ represents a (C₁-C₁₂)alkyl group.
Preferably, R³ represents a (C₁-C₆)alkyl group, more preferably a (C₁-C₄)alkyl group. In particular, R³ represents a methyl or an ethyl. R³ is not substituted.
Preferably, R⁴ represents a (C₁-C₁₂)alkyl group, preferably a (C₁-C₅)alkyl group, even more preferably a (C₁-C₆)alkyl group, even more preferably a (C₁-C₄)alkyl group. In particular, R⁴ represents a methyl or an ethyl. In this embodiment, R⁴ is not substituted.
Preferably R⁴ represents a —CH₂—O—R⁵ group, wherein R⁵ is as disclosed above.
Preferably, R⁵ is chosen from:
   a (C₁-C₁₂)alkyl group not substituted or substituted by a —O—(C₁-C₁₂)alkyl group, preferably by a —O—(C₁-C₆)alkyl group, more preferably by a —O—(C₁-C₄)alkyl group, and
   a (C₃-C₁₂)cycloalkyl group not substituted or substituted by a —O—(C₁-C₁₂)alkyl group, preferably by a —O—(C₁-C₆)alkyl group, more preferably by a —O—(C₁-C₄)alkyl group.
Preferably, R⁵ represents a (C₁-C₁₂)alkyl group not substituted or substituted as disclosed above, more preferably (C₁-C₁₀)alkyl group not substituted or substituted as disclosed above, even more preferably (C₁-C₅)alkyl group not substituted or substituted as disclosed above, even more preferably (C₁-C₇)alkyl group not substituted or substituted as disclosed above, even more preferably a (C₁-C₆)alkyl group not substituted or substituted as disclosed above, even more preferably (C₁-C₄)alkyl group not substituted or substituted as disclosed above, even more preferably a c (C₁-C₂)alkyl group not substituted or substituted as disclosed above. In particular, R⁵ represents a methyl, an ethyl, a n-propyl, a n-butyl, a n-pentyl, a n-hexyl, a n-heptyl or a n-octyl, preferably R⁵ represents a methyl, an ethyl, a n-propyl, a n-butyl, a n-pentyl, a n-hexyl, more preferably R⁵ represents a methyl, an ethyl, a n-propyl, a n-butyl.
Preferably, R⁶ represents a (C₃-C₁₂)cycloalkyl group not substituted or substituted as disclosed above, more preferably a (C₅-C₆)cycloalkyl group not substituted or substituted as disclosed above. For example, R⁵ represents a (C₅-C₆)cycloalkyl group substituted by a —O—(C₁-C₆)alkyl group. For example, R⁵ represent a (C₅-C₆)cycloalkyl group substituted by a —O—(C₁-C₄)alkyl group.

In particular, monomer M2 is a monomer M2′ of formula (IIa) as follows:

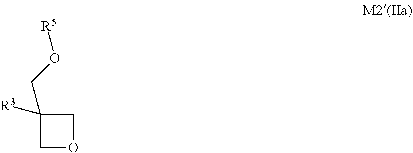

wherein R³ and R⁵ are as defined above.

The polymer P can be an homopolymer or a copolymer. The copolymer can be a statistic copolymer or a block copolymer. Preferably monomers are exclusively chosen from the group consisting of monomer M1, monomer M2 and combinations thereof. In addition to the constitutive units resulting from polymerization of monomer M1 and/or M2, polymer P may comprise the residue R^{x} of an initiator and the residue R^{v} of the terminating agent, as explained below. In addition the constitutive units resulting from polymerization of monomer M1 and/or M2, polymer P may comprise a (C₁-C₂₀)alkylene group interrupting the chain of constitutive units, linking two constitutive units, especially linking block B1 and block B2. In particular, the divalent group is a (C₁-C₁₂)alkylene group, preferably (C₁-C₅)alkylene group, more preferably a (C₁-C₆)alkylene group. In the following divalent group is noted R^{DG}.

The polymer P can comprise x block(s) B1 and y block(s) B2, wherein block B1 is prepared by polymerization of monomer M1 as described above and block B2 is prepared by polymerization of monomer M2 as described above.
x and y, independently of each other, are integer
x≥0, advantageously x ranges from 0 to 20, in particular x=0 or x=1 or x=2,
y≥0, advantageously y ranges from 0 to 20, in particular y=0 or y=1 or y=2,
at least one of x or y is different from 0.

In particular, polymer P is chosen from an homopolymer H1, an homopolymer H2 and a copolymer C, wherein
homopolymer H1 is a polymer P with x=1 and y=0,
homopolymer H2 is a polymer P with x=0 and y=1,
copolymer C is chosen from block polymer P with x 1 and y 1 or statistic polymer P (here x and y are not relevant).

Homopolymer H1 is a linear polymer prepared by polymerization of monomer M1 with R¹ and R² as described above. Homopolymer H1 is a polymer with antifoaming properties.

Homopolymer H2 is a linear polymer prepared by polymerization of monomer M2 with R³ and R⁴ as described above. In particular, homopolymer H2 is a linear polymer prepared by polymerization of monomer M2′ with R³ and R⁵ as described above. Homopolymer H2 is a polymer with antifoaming properties.

Copolymer C is a polymer with antifoaming properties. It is a linear polymer chosen from a statistic copolymer prepared by polymerization of monomers M1 and M2 or a block copolymer comprising x block(s) B1 and y block(s) B2, wherein blocks B1, B2 are as defined above, x≥1 and y 1. In particular, copolymer C is chosen from a diblock copolymer or a triblock copolymer.

Advantageously, polymer P has a number average molar mass Mn comprised from 400 g/mol to 30 000 g/mol.

In particular, polymer P has a Mn comprised from 400 g/mol to 10 000 g/mol, more preferably from 400 g/mol to 8 000 g/mol, even more preferably from 450 g/mol to 7 500 g/mol.

Alternatively, polymer P has preferably a Mn comprised from 10 500 g/mol to 30 000 g/mol, more preferably from 13 000 g/mol to 30 000 g/mol, even more preferably from 15 000 g/mol to 27 000 g/mol.

Preferentially, polymer P has a degree of polymerization DP comprised from 2 to 220, preferably from 3 to 220.

In particular, polymer P has a degree of polymerization DP comprised from 2 to 75, more preferably from 3 to 75, even more preferably from 2 to 60, even more preferably from 3 to 60, even more preferably from 2 to 55, even more preferably from 4 to 55, even more preferably from 2 to 50, even more preferably from 4 to 50.

Alternatively, polymer P has a degree of polymerization DP comprised from 76 to 220, more preferably from 95 to 220, even more preferably from 110 to 200.

Preferably, the polymer P has a polydispersity index PDI comprised from 1 to 3, more preferably from 1 to 2, even more preferably comprised from 1.0 to 1.5.

Polymer P is a linear polymer which can be obtained by ring-opening polymerization of monomer M1 and/or monomer M2.

In particular, polymer P can be obtained by cationic ring-opening polymerization (CROP) of monomer M1 and/or monomer M2.

In the present invention, CROP is performed in presence of a catalyst and terminated with a terminating agent.

In particular, polymer P is polymerized in the presence of a catalyst such as Lewis acid or a Bronsted acid. In particular, the Lewis acid is chosen from BF₃, AlCl₃, TiCl₄, SnCl₄, Ti(OiPr)₄, ZnI₂, SiF₄, SbF₅, PFs, AsF₅ and SbU₅, metal triflates (such as Fe(OTf)₃, Sc(OTf)₃, Y(OTf)₃). More particularly, the Lewis acid is chosen from BF₃·Et₂O, BF₃·CH₃COOH, AlCl₃, TiCl₄, SnCl₄, Ti(OiPr)₄ and metal triflate. Preferably, the Bronsted acid is chosen from FSO₃H, ClSO₃H, HClO, CF₃SO₃H, an acidic ion exchange resin and H₂SO₄, more preferably, the Bronsted acid is H₂SO₄.

Preferably, the terminating agent is chosen from water, a compound comprising at least one function alcohol, a compound comprising at least one function carboxylic acid, ammonia, a compound comprising at least one function amine, HCl, H₂SO₄, HBr, and HF.

Notably, polymer P can be obtained by CROP as described in U.S. Pat. Nos. 4,393,199, 4,483,978, 4,806,613 or 5,210,153. In this case, polymer P is polymerized in the presence of a catalyst and an initiator.

In the present invention, an initiator can be used. As disclosed in U.S. Pat. No. 4,393,199, the initiator can be a compound comprising at least one function chosen from an alcohol, an ether, a carboxylic acid, an ester, an anhydride, a ketone, and an aldehyde.

Furthermore, contrary to the teaching of U.S. Pat. No. 4,393,199, the inventors surprisingly discovered that a compound comprising a cyclic ether, in particular an oxetane, can be used as an initiator.

In addition, to that teaching, the polymerisation reaction can also be conducted without initiator, with however the consequence that the degree of polymerization of the polymer is not controlled.

Polymer P is preferably of formula (III):

R^{x}—O-[CU]-R^{y} (III)
wherein
R^{x} is the residue of initiator or R^{x} represents H,
R^{y} is the residue of terminating agent.

Notation [CU] represents the constitutive units obtained by polymerization of monomer chosen from monomer M1, monomer M2, or monomer M1 and monomer M2. [CU] can further comprise at least one divalent group —R^{DG}—, linking two constitutive units, as defined above.

In one embodiment [CU] represents x block(s) B1 and y block(s) B2, x and y being as described above. For example, [CU] can be B1, B2, B1-B2, B1-R^{DG}-B2, B2-B1, B2-R^{DG}-B1, B1-B2-B1, B2-B1-B2, B1-R^{DG}-B2-R^{DG}-B1, B2-R^{DG}-B1-R^{DG}-B2.

In another embodiment [CU] represents constitutive units resulting from polymerization of monomer M1 or M2 statistically distributed.

Specifically, R^{x} is chosen from:
a hydrogen atom,
a —CO—(C₁-C₂₀)alkyl group optionally substituted by at least one group —R^{z}, wherein R^{z} is chosen from:
   a hydroxyl group (OH),
   a —O—(C₁-C₁₂)alkyl group,
   an aliphatic 5- or 6-membered heterocycle, and
   an aliphatic 5- or 6-membered carbocycle.
a phenyl,
a benzyl,
a (C₁-C₂₀)alkyl group optionally substituted by at least one group —R^{z}, wherein R^{z} is as defined above.

In an embodiment, R^{x} is a hydrogen atom. In such a case, the polymerization is performed without initiator. In that embodiment, polymer P has preferably a Mn comprised from 10 000 g/mol to 30 000 g/mol, more preferably from 13 000 g/mol to 30 000 g/mol, even more preferably from 15 000 g/mol to 27 000 g/mol.

In another embodiment, R^{x} is chosen from a phenyl or a benzyl. In such a case, the polymerization is performed with initiator, being respectively chosen from phenol or benzylic alcohol. In that embodiment, polymer P has preferably a Mn comprised from 400 g/mol to 10 000 g/mol, more preferably from 400 g/mol to 8 000 g/mol, even more preferably from 450 g/mol to 7 500 g/mol.

In another embodiment, R^{x} is chosen from:
a —CO—(C₁-C₂₀)alkyl group optionally substituted by at least one group —R^{z}, wherein R^{z} is as defined above, and
a (C₁-C₂₀)alkyl group optionally substituted by at least one group —R^{z}, wherein R^{z} is as defined above.

In such a case, the polymerization is performed with an initiator. In that embodiment, polymer P has preferably a Mn comprised from 400 g/mol to 10 000 g/mol, more preferably from 400 g/mol to 8 000 g/mol, even more preferably from 450 g/mol to 7 500 g/mol.

Preferably, R^{z} is chosen from:
one or two or three, preferably one or two, hydroxyl group (OH),
one or two or three, preferably one or two, —O—(C₁-C₁₂)alkyl group, preferably-O—(C₁-C₆)alkyl group, more preferably —O—(C₁-C₄)alkyl group, even more preferably-O—(C₁-C₂)alkyl group,
an aliphatic 5- or 6-membered heterocycle, preferably a tetrahydrofuryl group, and
an aliphatic 5- or 6-membered carbocycle.

Specifically, R^{x} represents a (C₁-C₂₀)alkyl group not substituted or substituted by at least one, preferably one or two, group —R^{z}, wherein R^{z} is as defined above.

In this case, the polymerization is performed with an initiator which is preferably a compound comprising at least one function alcohol of formula R^{x}OH or an aliphatic 4- or 5- or 6-membered heterocycle, the heteroatom being an oxygen atom.

Preferably, R^{x} represents a (C₁-C₁₂)alkyl group, more preferably a (C₁-C₁₀)alkyl group, even more preferably a (C₁-C₆)alkyl group, even more preferably a (C₁-C₅)alkyl group. In all these embodiments, the alkyl group is not substituted or substituted by at least one, preferably one or two, group —R^{z}, wherein R^{z} is as disclosed above.

Specifically, R^{x} is a —CH₂—C(R⁶)(R⁷)—CH₂—OH group wherein R⁶ and R⁷, independently of each other, is chosen from a (C₁-C₁₂)alkyl group, preferably a (C₁-C₁₆)alkyl group, more preferably a (C₁-C₄)alkyl group. In this case, the polymerization is performed with oxetane as initiator.

Preferably, R^{x} is chosen from methyl, ethyl, n-propyl, isopropyl, n-butyl, isobutyl, sec-butyl, tert-butyl, n-pentyl, sec-amyl, tert-amyl, 2,2-dimethylpropyl, n-hexyl, 2,2-methylethylpropyl n-heptyl, 2,2-diethylpropyl, n-octyl, n-nonyl, n-decyl, n-undecyl, n-dodecyl, and from the following radicals:

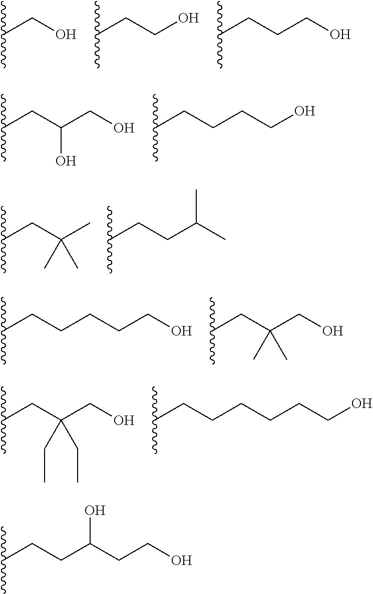

Preferably, R^{x} represents a (C₁₀-C₂₀)alkyl group, more preferably a (C₁₂-C₂₀)alkyl group, even more preferably a (C₁₄-C₂₀)alkyl group. In all these embodiments, the alkyl group is not substituted or substituted by at least one, preferably one or two, group —R^{z}, wherein R^{z} is as disclosed above.

Preferably, R^{x} is chosen from n-decyl, n-undecyl, n-dodecyl, n-tridecyl, n-tetradecyl, n-pentadecyl, n-hexadecyl, n-heptadecyl, n-octadecyl, n-nonadecyl, n-icosacyl.

Specifically, R^{x} represents a —CO—(C₁-C₂₀)alkyl group not substituted or substituted by at least one, preferably one or two, group —R^{z}, wherein R^{z} is as defined above.

In this case, the polymerization is performed with an initiator which is a compound comprising at least one function chosen from a carboxylic acid, an ester, or an anhydride. In particular, the preinitiator is a compound comprising at least one function carboxylic acid of formula R^{x}OH.

Preferably R^{x} represents a —CO—(C₁-C₁₂)alkyl group, preferably a —CO—(C₁-C₁₀)alkyl group, more preferably a —CO—(C₁-C₆)alkyl group, even more preferably a —CO—(C₁-C₄)alkyl group, even more preferably a —CO—(C₁-C₂)alkyl group. In all these embodiments, the alkyl group is not substituted or substituted by at least one, preferably one or two, group —R^{z}, wherein R^{z} is as disclosed above.

Preferably R^{x} represents a —CO—(C₁₀-C₂₀)alkyl group, preferably a —CO—(C₁₂-C₂₀)alkyl group, more preferably a —CO—(C₁₄-C₂₀)alkyl group. In all these embodiments, the alkyl group is not substituted or substituted by at least one, preferably one or two, group —R^{z}, wherein R^{z} is as disclosed above.

R^{y} is the residue of terminating agent.

Specifically, R^{v} is chosen from:
a hydrogen atom,
a —CO—(C₁-C₂₀)alkyl group optionally substituted by at least one group R^{v}, and
a (C₁-C₂₀)alkyl group optionally substituted by at least one group R^{v},

wherein R^{v} is chosen from:
a hydroxyl group (OH),
a —O—(C₁-C₁₂)alkyl group,
a phenyl,
a benzyl,
an aliphatic 5- or 6-membered heterocycle, and
an aliphatic 5- or 6-membered carbocycle,
a halogen atom chosen from Cl, Br and F,
—SO₃H,
—NH₂ or —NH—(C₁-C₆)alkyl group.

In particular, R^{v} is chosen from:
a hydroxyl group, and
a —O—(C₁-C₁₂)alkyl group, preferably a —O—(C₁-C₆)alkyl group, more preferably a —O—(C₁-C₄)alkyl group.

Preferably, R^{y} represents a hydrogen atom.

In this case, the polymerization is terminated with water as terminating agent.

Specifically, R^{y} represents a halogen atom chosen from Cl, Br and F.

In this case, the polymerization is respectively terminated with HCl, HBr of HF as terminating agent.

Specifically, R^{y} represents —SO₃H.

In this case, the polymerization is terminated with H₂SO₄ as terminating agent.

Specifically, R^{v} represents NH₂ or —NH—(C₁-C₆)alkyl group.

In this case, the polymerization is terminated with ammonia or an amine as terminating agent.

Specifically, R^{y} represents a —CO—(C₁-C₂₀)alkyl group not substituted or substituted by at least one, preferably one or two, group —R^{v}, wherein R^{v} is as defined above.

In this case, the polymerization is preferably terminated with a compound comprising at least one function carboxylic acid of formula R^{y}OH.

Preferably R^{v} represents a —CO—(C₁-C₁₂)alkyl group, preferably a —CO—(C₁-C₁₀)alkyl group, more preferably a —CO—(C₁-C₆)alkyl group, even more preferably a —CO—(C₁-C₄)alkyl group, even more preferably a —CO—(C₁-C₂)alkyl group. In all these embodiments, the alkyl group is not substituted or substituted by at least one, preferably one or two, group —R^{v}, wherein R^{v} is as disclosed above.

Preferably R^{v} represents a —CO—(C₁₀-C₂₀)alkyl group, preferably a —CO—(C₁₂-C₂₀)alkyl group, more preferably a —CO—(C₁₄-C₂₀)alkyl group. In all these embodiments, the alkyl group is not substituted or substituted by at least one, preferably one or two, group —R^{v}, wherein R^{v} is as disclosed above.

Specifically, R^{y} represents a (C₁-C₂₀)alkyl group not substituted or substituted by at least one, preferably one or two, group —R^{v}, wherein R^{v} is as defined above.

In this case, the polymerization is terminated with a compound comprising at least one function alcohol of formula R^{y}OH.

Preferably, R^{v} represents a (C₁-C₁₂)alkyl group, more preferably a (C₁-C₁₀)alkyl group, even more preferably a (C₁-C₆)alkyl group, even more preferably a (C₁-C₅)alkyl group. In all these embodiments, the alkyl group is not substituted or substituted by at least one, preferably one or two, group —R^{v}, wherein R^{v} is as disclosed above.

Preferably, R^{v} represents a (C₁₀-C₂₀)alkyl group, more preferably a (C₁₂-C₂₀)alkyl group, even more preferably a (C₁₄-C₂₀)alkyl group. In all these embodiments, the alkyl group is not substituted or substituted by at least one, preferably one or two, group —R^{v}, wherein R^{v} is as disclosed above.

Advantageously, R^{x} and R^{y} are each a hydrogen atom.

Advantageously, polymer P is chosen from polymer of formula (IV) to (XIII):

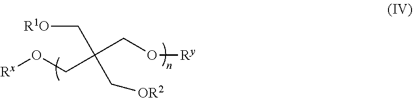

wherein n is an integer comprised between 3 and 220, advantageously between 6 and 220, and R¹, R², R^{x} and R^{y} are as described above.

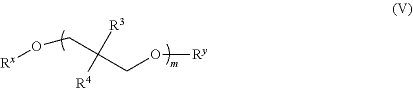

wherein m is an integer comprised between 3 and 220, advantageously between 6 and 220, and R³, R⁴, R^{x} and R^{y} are as described above.

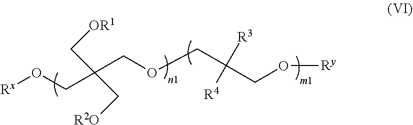

wherein n1 and m1, independently of each other, are an integer comprised between 1 and 220,
and 3≤n1+m1≤220, advantageously 6≤n1+m1≤220
R¹, R², R³, R⁴, R^{x} and R^{y} are as described above;

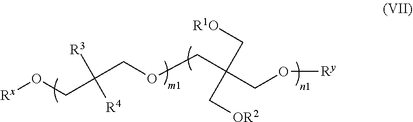

wherein n1 and m1, independently of each other, are an integer comprised between 1 and 220,
and 3≤n1+m1≤220, advantageously 6≤n1+m1≤220
R¹, R², R³, R⁴, R^{x} and R^{y} are as described above.

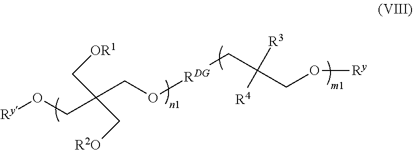

wherein n1 and m1, independently of each other, are an integer comprised between 1 and 220,
and 3≤n1+m1≤220, advantageously 6≤n1+m1≤220
R^{DG} is a (C₁-C₂₀)alkylene group, preferably a (C₁-C₁₂)alkylene group, more preferably a (C₁-C₈)alkylene group, even more preferably a (C₁-C₆) alkylene group
R^{y′} has the same definition as that given for R^{y} as defined above and is different or the same as R^{y}. R^{y} and R^{y′} are preferably H
R¹, R², R³, R⁴, R^{x} and R^{y} are as described above

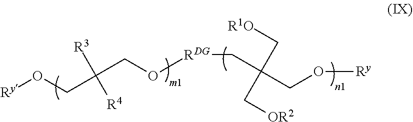

wherein n1 and m1, independently of each other, are an integer comprised between 1 and 220,
and 3≤n1+m1≤220, advantageously 6≤n1+m1≤220
R^{DG} is a (C₁-C₂₀)alkylene group, preferably a (C₁-C₁₂)alkylene group, more preferably a (C₁-C₅)alkylene group, even more preferably a (C₁-C₆)alkylene group
R^{y′} has the same definition as that given for R^{y} as defined above and is different or the same as R^{y}. R^{y} and R^{y′} are preferably H
R¹, R², R³, R⁴, R^{x} and R^{v} are as described above

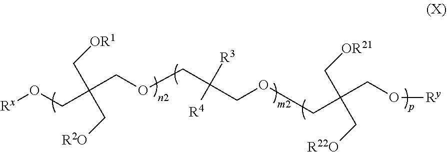

wherein n2, m2 and p, independently of each other, are an integer comprised between 1 and 220,
and 3≤n2+m2+p≤220, advantageously 6≤n2+m2≤220
R¹, R², R³, R⁴, R^{x} and R^{y} are as described above,
R¹¹ has the same definition as that given for R¹ as defined above and is different or the same as R¹,
R²¹ has the same definition as that given for R² as defined above and is different or the same as R².

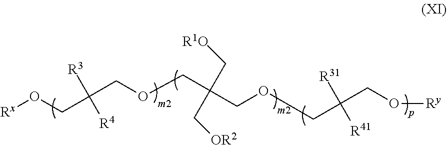

wherein n2, m2 and p, independently of each other, are an integer comprised between 1 and 220, and 6≤n2+m2≤220, advantageously 6≤n2+m2≤220
R¹, R², R³, R⁴, R^{x} and R^{v} are as described above,
R³¹ has the same definition as that given for R³ as defined above and is different or the same as R³,
R⁴¹ has the same definition as that given for R⁴ as defined above and is different or the same as R⁴.

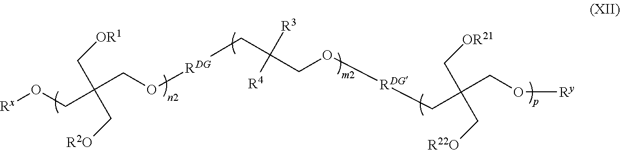

wherein n2, m2 and p, independently of each other, are an integer comprised between 1 and 220,
and 6≤n2+m2≤220, advantageously 6≤n2+m2+p≤220
R¹, R², R³, R⁴, R^{x} and R^{y} are as described above,
R^{DG}, R^{DG′}, independently of each other, is a (C₁-C₂₀)alkylene group, preferably a (C₁-C₁₂)alkylene group, more preferably a (C₁-C₈)alkylene group, even more preferably a (C₁-C₆)alkylene group
R^{y′} has the same definition as that given for R^{v} as defined above and is different or the same as R^{y}. R^{v} and R^{y′} are preferably H
R¹¹ has the same definition as that given for R¹ as defined above and is different or the same as R¹,
R²¹ has the same definition as that given for R² as defined above and is different or the same as R².

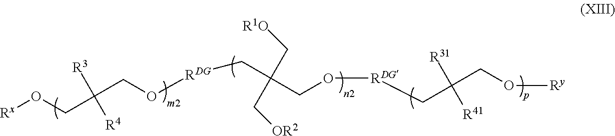

wherein n2, m2 and p, independently of each other, are an integer comprised between 1 and 220,
and 6≤n2+m2≤220, advantageously 6≤n2+m2+p≤220
R¹, R², R³, R⁴, R^{x} and R^{y} are as described above,
R^{DG}, R^{DG′}, independently of each other, is a (C₁-C₂₀)alkylene group, preferably a (C₁-C₁₂)alkylene group, more preferably a (C₁-C₅)alkylene group, even more preferably a (C₁-C₆)alkylene group
R^{y′} has the same definition as that given for R^{v} as defined above and is different or the same as R^{y}. R^{v} and R^{y′} are preferably H
R³¹ has the same definition as that given for R³ as defined above and is different or the same as R³,
R⁴¹ has the same definition as that given for R⁴ as defined above and is different or the same as R⁴.

### Process for Manufacturing Polymer P

Polymer P is a linear polymer which can be obtained by ring-opening polymerization of monomer M1 and/or monomer M2.

In particular, polymer P can be obtained by cationic ring-opening polymerization (CROP) of monomer M1 and/or monomer M2.

Advantageously, CROP is performed in presence of a catalyst and terminated with a terminating agent. The catalyst is as described previously.

In a first embodiment, polymer P can be obtained by a method of manufacture using a catalyst and an initiator. The group R^{x} is then a residue of the initiator.

In a first embodiment, the method of manufacture of a polymer P comprises the following steps:
(a1) mixing a catalyst and an initiator chosen from an initiator of formula R^{x}OH, wherein R^{x} is as defined previously, or an oxetane,
(b1+c1) adding monomers M1 and/or M2; (d) then, adding a terminating agent.

When the polymer is an homopolymer, step (b1+c1) is a sole step wherein monomer M1 or M2 is added.

When the polymer is a copolymer:

Step (b1+c1) can be a sole step (also called step (b1)) wherein monomers M1 and M2 are added in the same step and the polymerization obey to the statistic rules leading to a statistic copolymer.

Alternatively, step (b1+c1) can represent two successive different steps (b1) and (c1) of:
(b1) adding to the mixture obtained after step (a1) a monomer chosen from monomer M1 or monomer M2 to form block B1 or respectively block B2,
(c1) adding to the mixture obtained after step (b1) a monomer chosen from monomer M2 or monomer M1 and different from the monomer of step (b1) to form a second block B2 or respectively B1, said step being repeated to form the number of blocks B1 and B2 sought with alternance of addition of monomer M1 or monomer M2;
   leading to a block copolymer.

The terminating agent is as disclosed previously and below.

Specifically, the oxetane is a formula (XIV)

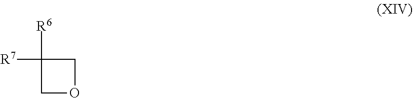

wherein R¹ and R⁷ are as defined previously.

Advantageously, the amount of initiator in step (a1) is comprised 0.1% mol to 100% mol for 1 mol of a monomer chosen from monomer M1 or monomer M2.

Advantageously, when the initiator is an oxetane of formula (XIV), the molar ratio of catalyst/initiator is comprised from 40/60, to 60/40, more advantageously it is 50/50.

Advantageously, when the initiator comprises one or many hydroxyl functions (OH), the molar amount of catalyst is between 0.8 and 1.2 equivalent per OH function of the initiator, more advantageously 1 equivalent per OH function of the initiator.

In a second embodiment, polymer P can be obtained by a method of manufacture using a catalyst. No initiator is used. Then, the group R^{x} represent a hydrogen atom.

In this embodiment, the method of manufacture of a polymer P comprises the following steps:
(b2) mixing a catalyst and a monomer chosen from monomer M1 or monomer M2 or combination thereof
(d) then, adding a terminating agent.

When a block copolymer is sought, in step (b2) a monomer chosen from monomer M1 or monomer M2 is added to form block B1 or block B2 respectively, and the process further comprises step (c2) of adding to the mixture obtained after step (b2) a monomer chosen from monomer M2 or monomer M1 and different from the monomer of step (b2) to form a second block B2 or respectively B1, said step being repeated to form the number of blocks B1 and B2 sought with alternance of addition of monomer M1 or monomer M2.

In both embodiments, preferably, the process does not comprise polymerization of a monomer different from monomer M1 or monomer M2.

In the following, the term “step (bi)” will refer to step (b1) or step (b2) and the term “step (ci)” will refer to step (c1) or step (c2), depending on whether an initiator is used or not.

If step (ci) is performed, a diblock polymer is obtained. When a monomer M1 is chosen in step (bi), then a monomer M2 is chosen in step (ci). Alternatively, when a monomer M2 is chosen in step (bi), then a monomer M1 is chosen in step (ci).

Step (ci) can be repeated to form the number of blocks B1 and B2 sought with alternance of addition of monomer M1 or monomer M2. Accordingly, after step (ci) and before step (d), a step (ci) is performed again but with the other monomer, repeated step (ci) consisting in adding to the mixture obtained previously a monomer chosen from monomer M1 or monomer M2 and different from the monomer of previous step to form a third block B1 or respectively B2.

If step (ci) is repeated once, with the alternance of monomer addition, a triblock polymer is obtained.

If step (ci) is repeated twice, with the alternance of monomer addition, a quadriblock polymer is obtained.

In a third embodiment, the method of manufacture of a polymer P comprises the following steps:
(a3) mixing a catalyst and an initiator, the initiator being a diol, advantageously a compound of formula R^{x}OH wherein R^{x} is a (C₁-C₂₀)alkyl group substituted by one hydroxyle group,
(b3) adding to the mixture obtained in step (a3) a monomer chosen from monomer M1 to form block B1 or monomer M2 to form block B2 or monomers M1 and M2 to form statistic block,
(d3) adding to the mixture obtained after step (b3) a terminating agent,
(a4) mixing a catalyst and the polymer resulting from step (d3),
(b4) adding to the mixture obtained in step (a4) a monomer chosen from monomer M2 or monomer M1 and different from the monomer of step (b3) to form a second block B2 or respectively B1 or monomers M1 and M2 to form statistic block,
(d4) then, adding a terminating agent.

As previously described, when the terminating agent used in step (d4) is a diol, advantageously a compound of formula R^{y}OH wherein R^{y} is a (C₁-C₂₀)alkyl group substituted by one hydroxyl group, then steps (a4) to (d4) can be repeated to manufacture a multiblock such as triblock or a quatriblock.

In this embodiment, the blocks chosen from block B1, block B2 and statistic blocks are linked through a divalent group R^{DG} as previously described.

Advantageously, the molar amount of catalyst is between 0.8 and 1.2 equivalent per OH function of the initiator, more advantageously 1 equivalent per OH function of the initiator. Accordingly, in step (a3) 2 equivalents of catalyst are used for 1 equivalent of initiator (the initiator is a diol) while is step (a4) 1 equivalents of catalyst are used for 1 equivalent of initiator (the initiator is the polymer with R^{x} having one OH group).

In all embodiments, in step (d), including steps (d3) and (d4), the terminating agent is chosen from water, a compound comprising at least one function alcohol, a compound comprising at least one function carboxylic acid, ammonia, a compound comprising at least one function amine, HCl, H₂SO₄, HBr and HF.

When the terminating agent is water, the residue R^{y} of polymer P represents H.

When the terminating agent is a compound comprising at least one function alcohol or a compound comprising at least one function carboxylic acid, it can be a compound of formula R^{y}OH, with R^{y} being
a hydrogen atom,
a —CO—(C₁-C₂₀)alkyl group optionally substituted by at least one group R^{v} and
a (C₁-C₂₀)alkyl group optionally substituted by at least one group R^{v},
wherein R¹¹ is chosen from
   a hydroxyl group (OH),
   a —O—(C₁-C₁₂)alkyl group,
   a phenyl,
   a benzyl,
   an aliphatic 5- or 6-membered heterocycle and
   an aliphatic 5- or 6-membered carbocycle.

In particular, the catalyst is a Lewis acid or a Bronsted acid. In particular, the Lewis acid is chosen from BF₃, AlCl₃, TiCl₄, SnCl₄, Ti(OiPr)₄, ZnI₂, SiF₄, SbF₅, PFs, AsF₅ and SbU₅, metal triflates (such as Fe(OTf)₃, Sc(OTf)₃, Y(OTf)₃). More particularly, the Lewis acid is chosen from BF₃·Et₂O, BF₃·CH₃COOH, AlCl₃, TiCl₄, SnCl₄, Ti(OiPr)₄ and metal triflate. Preferably, the Bronsted acid is chosen from FSO₃H, ClSO₃H, HClO, CF₃SO₃H, an acidic ion exchange resin and H₂SO₄, more preferably, the Bronsted acid is H₂SO₄.

In particular, polymerisation is conducted in a solvent. The solvent is usually added in step (a1) or (a2) or (a3) or (a4). Any Solvent suitable for CROP polymerisation can be used, specifically a polar aprotic solvant. For example, the solvent can be chosen from dichloromethane, chloroform, ClCH₂—CH₂—Cl, nitromethane, chlorobenzene, fluorobenzene, pentane and methylTHF. Preferably the solvent is methylTHF.

Otherwise, the polymerization can be conducted without solvent.

Preferably, the amount of catalyst mixed in step (a1) or (a2) (a3) or (a4) is comprised from 0.05 mol % to 50 mol %, more particularly from 5 mol % to 30 mol %, compared to the molar amount of a monomer added in step (b1) or (b2) or (b3) or (b4).

Advantageously, the amount of terminating agent in step (d) is equal or superior to the number of molar equivalents of initiator.

In particular, steps of polymerisation, i.e., steps (bi) and optionally steps (ci), (ci′) and (ci″), are each run at a temperature comprised from −15° C. to 100° C., preferably from −12° C. to 90° C.

In particular, the process is conducted under inert atmosphere, for example under argon atmosphere.

The present invention deals also with the polymer P obtained by the method of manufacture disclosed above, according to the first or the second or the third embodiment.

Polymer P′

The invention also relates to a specific polymer, called polymer P′, being a polymer P as described above, prepared by copolymerization of monomer M1 and monomer M2.

Accordingly, polymer P′ is chosen from a statistic copolymer P or a block polymer P wherein x and y, independently of each other, are integer from ≥1, advantageously ranging from 1 to 2.

The number average molar mass Mn of polymer P′ is comprised from 400 g/mol to 30 000 g/mol.

Polymer P′ is not prepared by copolymerization of monomer M1, monomer M2 and THF.

Polymer P′ is a copolymer with antifoaming properties.

As previously disclosed, and as shown in examples, polymer P′ can be used to reduce the volume of foam.

More particularly, polymer P′ reduces the volume of foam by at least 20 vol %, preferably by at least 50 vol. %, more preferably by at least 70 vol %, relative to the total initial volume of foam.

In an embodiment, polymer P′ is a linear polymer comprising x block(s) B1 and y block(s) B2, wherein B1, B2, x and y are as described above with x≥1 and y≥1, and

the number average molar mass Mn of polymer P′ is comprised from 400 g/mol to 30 000 g/mol.

In particular, polymer P′ (being a statistic or a block copolymer) has a Mn comprised from 400 g/mol to 10 000 g/mol, more preferably from 400 g/mol to 8 000 g/mol, even more preferably from 450 g/mol to 7 500 g/mol.

Alternatively, polymer P′ (being a statistic or a block copolymer) has preferably a Mn comprised from 10 500 g/mol to 30 000 g/mol, more preferably from 13 000 g/mol to 30 000 g/mol, even more preferably from 15 000 g/mol to 27 000 g/mol.

In both cases, preferably, the polymer P′ has a polydispersity index PDI comprised from 1.0 to 31.2, more preferably from 1.0 to 1.12, even more preferably comprised from 1.0 to 1.5.

Preferentially, polymer P′ (being a statistic or a block copolymer) has a degree of polymerization DP comprised from 3 to 220.

In particular, polymer P′ has a degree of polymerization DP comprised from 3 to 75, more preferably, from 3 to 60, even more preferably from 4 to 55.

Alternatively, polymer P′ has a degree of polymerization DP comprised from 76 to 220, more preferably from 95 to 220, even more preferably from 110 to 200.

Polymer P′ can be manufactured by implementing the manufacturing process previously described comprising at least a step (ci) when the copolymer is a block copolymer, in particular according to its first embodiment.

### Antifoam Composition

Preferably, the amount of polymer P in the antifoam composition is comprised between 0.01 wt. % and 100 wt. % compared to the total weight of the antifoam composition, more preferably from 1 wt. % to 90 wt. %, even more preferably from 25 wt. % to 75 wt. %.

In particular, the antifoam composition is an emulsion. More particularly, the antifoam composition is a water-in-oil emulsion. Alternatively, the antifoam composition is an oil-in-water emulsion.

Advantageously, the antifoam composition comprises also a substance chosen among stabilator, emulsifier, antioxidant agent, preservative, thickener, charge, and mixture thereof. For example, the comprises also a substance chosen among natural fat, hydrocarbons, organic/inorganic charges, silicones, and mixture thereof. For example, the comprises also a substance chosen among a mineral, vegetable or animal oil, a wax, a fatty acid, a fatty acid ester, a fatty alcohol, glycerol ester, sorbic acid, xanthane, and mixture thereof.

The antifoam composition can also comprise water.

In particular, the antifoam composition comprises in wt. % compared to the total weight of the antifoam composition:
from 0.01 to 100, advantageously from 20 to 80, of the polymer P according to the invention,
from 0 to 99.99, advantageously from 0 to 80, of a substance chosen among stabilator, emulsifier, antioxidant agent, preservative, thickener, charge, and mixture thereof,
the remaining, if any, being water.

Advantageously, the antifoam composition comprises in wt. % compared to the total weight of the composition:
From 20 to 80 wt. %, advantageously from 30 to 70 wt. %, more advantageously from 40 to 60 wt. %, of polymer P according to the invention,
From 10 to 70 wt. %, advantageously from 20 to 60 wt. %, more advantageously from 30 to 50 wt. %, of natural vegetable oil,
From 1 to 40 wt. %, advantageously from 1 to 20 wt. %, more advantageously from 2 to 10 wt. %, of natural fatty acid.

In particular, mineral, vegetable or animal oils can be oils of vegetable origin, such as sweet almond oil, avocado oil, castor oil, olive oil, jojoba oil, sunflower oil, wheat germ oil, sesame oil, groundnut oil, grape seed oil, soybean oil, rapeseed oil, safflower oil, coconut oil, corn oil, hazelnut oil, karite butter, palm oil, apricot kernel oil or calophyllum oil; oils of animal origin, of perhydrosqualene; oils of mineral origin, of liquid paraffin and liquid petrolatum; and of their mixtures.

Preferably, the wax can be animal, vegetable or mineral waxes. A wax is a lipophilic compound, solid at 25° C., with a reversible solid/liquid change of state, having a melting point of greater than 40° C., and exhibiting, in the solid state, an anisotropic crystalline arrangement. On bringing the wax to its melting point, it is possible to render it miscible with oils and to form a microscopically homogeneous mixture but, on bringing the temperature of the mixture back to ambient temperature, a recrystallization of the wax from the oils of the mixture is obtained which is detectable microscopically and macroscopically.

In particular, waxes which can be used are waxes of animal origin, such as beeswax, spermaceti, lanolin wax and lanolin derivatives; vegetable waxes, such as carnauba wax, candelilla wax, ouricury wax, Japan wax, cocoa butter or cork fiber or sugarcane waxes; mineral waxes, for example paraffin wax, petrolatum wax, lignite wax or microcrystalline waxes or ozokerites, and their mixtures.

In particular, fatty acid can be one or more branched or unbranched fatty acids, more particularly C₈-C₃₀ carboxylic acids, such as palmitic acid, oleic acid, linoleic acid, myristic acid, stearic acid, lauric acid, and their mixtures.

Preferably, fatty acid ester can be isopropyl myristate, isopropyl palmitate, 2-ethylhexyl palmitate, stearyl octanoate, isononyl isononanoate, isostearyl isononanoate, isopropyl lanolate, and their mixtures.

In particular, fatty alcohol can be C₈-C₃₀ alcohols, such as, for example, palmityl, oleyl, linoleyl, myristyl, stearyl and lauryl alcohols, and their mixtures.

### Methods and Reactive

All reagents and solvents used for synthesis are commercial and used without additional purification. Pentaerytritol is supplied by Aldrich. Trimethylolpropane is supplied by Sigma Aldrich. The polymerization solvents are of high purity and are supplied by Sigma Aldrich.

### CPG Method

The analysis by gas chromatography is carried out with a Shimadzu device (GC-2025) equipped with a capillary column (ZB-5-MS, 10 m, 0.10 mm in diameter, 0.10 μm thick). The carrier gas is dinitrogen, with a flow rate of 0.43 mL/min and the injection mode is split (ratio 1:100). The initial column temperature is 50° C., maintained for 3 minutes and gradually increases to 260° C. (25° C./min), then maintained for 2 minutes. The temperature of the injector and the FID detector are 300° C. and 315° C. respectively.

### SEC Method

The mass distribution of the polymers is analyzed using an Agilent steric exclusion chromatography system equipped with a gel column (Jordi DVB) (particle size=5 μm, length=25 cm, diameter=1 cm, range of detection=100-107 D) and a refractive index detector (Viscotek, Model TDA305). The measurements are carried out at 20° C. in the NMP with a flow rate of 1 ml/min, using a polystyrene standard.

### 1H NMR (NMR in the Examples)

The nuclear magnetic resonance spectra are performed on a Bruker DRX300 or Bruker ALS300 device (1H—300 MHz, 13C—75 MHz). The chemical shifts are given in ppm with as reference the characteristic peaks of MeOH or CHCl3 4.78 and 7.26 ppm for the proton, 49.86 and 77.16 ppm for the carbon, respectively. The values of J (coupling constant) are given in Hertz. The abbreviations are as follows: s=singlet, d=doublet, dd=doublet of doublet, t=triplet, q=quadruplet, m=multiplet.

### DSC

The DSC measurements are carried out with the DSC 3000 Mettler toledo from 25° C. to 180° C. (20° C./minutes), maintained for 5 min, then 180° C. to −30° C. The last segment is from −30° C. to 180° C. and maintained at this temperature for 5 minutes. The carrier gas is dinitrogen (200 mL/min for the cell and 50° C./minutes for the internal oven)

### EXAMPLES

DMO: monomer M2 of formula (II) wherein R³=R⁴=—CH₃
BMMO: monomer M1 of formula (I) wherein R¹=R²=—CH₃
EMMO: monomer M2 of formula (IIa) wherein R³=—C₂H₅ and R⁵=—CH₃
EBMO: monomer M2 of formula (IIa) wherein R³=—C₂H₅ and R⁵=—C₄H₉
EOMO: monomer M2 of formula (IIa) wherein R³=—C₂H₅ and R⁵=—C₈H₁
Th=theoretical
Exp=experimental
DPn=degree of polymerisation
PDi=index of polydispersity

### Preparation of Monomers:

In a 0.5 L flask equipped with a water cooler, polyol (1 equivalent), diethyl carbonate (1.1 equivalent) and KOH (1.5 mol %) were heated at 140° C. After distillation of diethyl carbonate, the media was heated during 2 h at 190° C. Oxetane was purified under vacuum distillation.

### Alkylation of Hydroxy Function of Oxetanes:

NaOH (1.5 eq./OH) was dissolved in water (2 mL/g), then cold down in an ice bath. Oxetane (1 eq.) was introduced in a 0.5 L 2 neck flask and NaOH solution was added dropwise with a dropping funnel. After 1 h in an ice bath under agitation, alkyl iodide (1.5 eq) is added dropwise. Reaction is heated at 100° C. during 5 h. After cooling down, organic phase is extracted with EtOAc. Aqueous phase is neutralized with sulfuric acid and extracted 3 times with EtOAc. Organic phases are combined and wash with NaCl saturated solution, dried over MgSO₄, filtrated, and concentrated under reduce pressure. Oxetane is purified by distillation under vacuum.

### Example 1—Preparation of Homopolymers without Initiator

In a 25 mL Schlenk tube purged with Argon, 1 equivalent of monomer oxetane was introduced with dichloromethane (2 mL) and 0.2 equivalent of catalyst (BF₃Et₂O) was added. The reaction is conducted at ambient temperature (about 21° C.). After 10 minutes, reaction was stopped by adding water. Organic phase was extracted 3 times with dichloromethane, dried over MgSO₄, filtrated, and concentrated under reduce pressure.

Following this procedure, the polymers disclosed in the table below have been prepared.

TABLE 1

| Monomer | Conversion | Yield | Mn* | PDi |
|---|---|---|---|---|
| DMO | 99% | >90% | 19 000 | 1.01 |
| BMMO | 99% | >90% | 21 500 | 1.05 |
| EMMO | 99% | >90% | 18 700 | 1.04 |
| EOMO (6) | 99% | >90% | 22 600 | 1.01 |

*determined by SEC

Very good yields as well as very low PDI are obtained. A short reaction time coupled with a very low PDI is coherent with the mechanism of a living CROP. An average Mn of 20,000 g/mol is obtained for the homopolymerization of the disubstituted 3,3 oxetanes.

### Example 2—Preparation of Diblocs without Initiator

In a 25 mL Schlenk tube purged with Argon, n equivalent of EMMO (first monomer oxetane) was introduced with dichloromethane (2 mL) and 20 mol % of catalyst (BF₃Et₂O) was added. The reaction is conducted at ambient temperature (about 21° C.). After 10 minutes, m equivalent of BMMO (second monomer oxetane) was introduced. The reaction is conducted at ambient temperature (about 21° C.). After 10 minutes, reaction was stopped by adding water. Organic phase was extracted 3 times with dichloromethane, dried over MgSO₄, filtrated, and concentrated under reduce pressure.

Following this procedure, the polymers disclosed in the table below have been prepared.

TABLE 2

| | | | Ratio | | Mn_{sec} | |
|---|---|---|---|---|---|---|
| n_{equivalentEMMO} | n_{equivalentsBMMO} | Conversion | RMN* | PDi | (g/mol) | Yield |
| 1 | 0 | 99% | 1:0 | 1.01 | 18 000 | 90% |
| 2 | 1 | 96% | 2:1 | 1.01 | 26 600 | 85% |
| 4 | 1 | 98% | 4:1 | 1.04 | 18 400 | 75% |
| 8 | 1 | 99% | 7.5:1 | 1.04 | 19 250 | 95% |
| 16 | 1 | 98% | 23:1 | 1.01 | 25 600 | 95% |

*the ratio of each block is determined by NMR.

With a methoxy function and an ethyl chain, the EMMO monomer is more hydrophobic than the BMMO monomer (which carries 2 methoxy functions but does not carry an ethyl chain). Adding BMMO repeating units to the copolymer provides hydrophilicity. The addition of ⅓ of hydrophilic monomer, ie a final ratio of 2:1 between the hydrophobic monomer and the hydrophilic monomer makes it possible to obtain a copolymer of 26,600 g/mol with 85% yield. The ratio between each monomer is confirmed by NMR. Similarly, the reduction of the hydrophilic part by 20%, then 10% and finally 5% makes it possible to obtain copolymers with excellent yields (75%-95%) and molecular weights of 18,400 to 25,600 g/mol. In accordance with the observations made during the homopolymerization (Example 1), the polydispersity of the copolymers obtained is very low. Living copolymerization provides access to amphiphilic polyethers with very good yields and Mn between 18,000 g/mol and 25,600 g/mol.

### Example 3—Homopolymerisation of EMMO Under Different Polymerisation Conditions without Initiator

In a 25 mL Schlenk tube purged with Argon, 1 equivalent of EMMO (monomer oxetane) was introduced with dichloromethane (X mL) and Y equivalent of catalyst was added. After Z minutes, reaction was stopped by adding water. Organic phase was extracted 3 times with dichloromethane, dried over MgSO₄, filtrated, and concentrated under reduce pressure.

### With Different Catalysts

The general procedure disclosed above was followed. 1 equivalent of EMMO was introduced with dichloromethane (2 mL). 20 mol % of catalyst is added; the nature of the catalyst varied. The reaction is conducted at ambient temperature (about 21° C.). The reaction is stopped after 10 min. Following this procedure, the polymers disclosed in the table below have been prepared.

TABLE 3

| Catalyst | Conversion | Yield | Mn (g/mol) | PDi |
|---|---|---|---|---|
| H₂SO₄ | 99% | >90% | 29 500 | 1.05 |
| BF₃Et₂O | 99% | >90% | 18 700 | 1.04 |
| BF₃AcOH | 99% | >90% | 19 000 | 1.04 |
| AlCl₃ | 99% | >90% | 40 100 | 1.02 |

### Catalyst Concentration

The general procedure disclosed above was followed. 1 equivalent of EMMO was introduced with dichloromethane (2 mL) The concentration of catalyst (BF₃Et₂O) varied. The reaction is conducted at ambient temperature (about 21° C.). The duration of reaction was also increased when the catalyst concentration was low. Following this procedure, the polymers disclosed in the table below have been prepared.

TABLE 4

| Catalyst amount | Reaction | | | | Mn | |
|---|---|---|---|---|---|---|
| (X mol %) | duration | | Conversion^{b} | Yield | (g/mol) | PDi |
| 5 | 10 | min | 99 | >90% | 18 400 | 1.01 |
| 10 | 10 | min | 99 | >90% | 19 200 | 1.01 |
| 20 | 10 | min | 99 | >90% | 18 700 | 1.04 |
| 0.1 | 14 | hours | 99 | >90% | 28 700 | 1.01 |
| 1 | 14 | hours | 99 | >90% | 23 100 | 1.01 |

^{b}Calculated by NMR

### Monomer Concentration

The general procedure disclosed above was followed. 20 mol % of catalyst (BF₃Et₂O) is added. The solvent content varied so that the monomer concentration varied. The reaction is conducted at ambient temperature (about 21° C.). The reaction is stopped after 10 min. Following this procedure, the polymers disclosed in the table below have been prepared.

TABLE 5

| Monomer | | | | |
|---|---|---|---|---|
| concentration | | | | |
| [C] (mol/L) | 1.8 mol/L | 1 mol/L | 0.1 mol/L* | 0.05 mol/L* |
| Mn (g/mol) | 29000 | 27800 | 33100 | 33100 |

*After total conversion of the monomer (reaction time = 16 h)
No correlation between monomer concentration and Mn of the polymer is noted.

### Reaction Time

The general procedure disclosed above was followed. 1 equivalent of EMMO was introduced with dichloromethane (2 mL). 20 mol % of catalyst (H₂SO₄) is added. The reaction is conducted at ambient temperature (about 21° C.). Reaction lasted from 1 min to 1 day. Following this procedure, the polymers disclosed in the table below have been prepared.

TABLE 6

| | | | | |
|---|---|---|---|---|
| Reaction | | | Mn | |
| duration | Conversion | Yield | (g/mol) | PDi |

| | | | | | |
|---|---|---|---|---|---|
| 2 | min | 90 | — | — | — |
| 10 | min | 99 | >90 | 29 100 | 1.01 |
| 1 | h | 99 | >90 | 29 900 | 1.01 |
| 3 | h | 99 | >90 | 29 900 | 1.01 |
| 24 | h | 99 | >90 | 31 800 | 1.01 |

### Temperature

The general procedure disclosed above was followed. 1 equivalent of EMMO was introduced with dichloromethane (2 mL). 20 mol % of catalyst (BF₃Et₂O) is added. The temperature varied. The duration of reaction was also increased when the temperature was negative. Following this procedure, the polymers disclosed in the table below have been prepared.

TABLE 7

| Temperature | Reaction | | | | | |
|---|---|---|---|---|---|---|
| (° C.) | duration | | Conversion | Yield | Mn (g/mol) | PDi |
| 20 | 10 | min | 99 | >90 | 18 700 | 1.04 |
| 50 | 10 | min | 99 | >90 | 17 700 | 1.04 |
| 80 | 10 | min | 99 | >90 | 19 100 | 1.01 |
| −10 | 17 | hours | 97 | >90 | 24 200 | 1.01 |

When the temperature decreases, the reaction is slower, but without significant impact on Mn of the polymer.

### Example 4—Polymerisation with Initiator

In a 25 mL Schlenk tube purged with Argon, X mmol of initiator and X mmol of catalyst (1 eq./OH function) were introduced with 2 mL of solvent (dichloromethane). After 1 hour, Y mmol of monomer oxetane solubilized in solvent (dichloromethane) was added. After Z min, reaction was stopped by adding termination agent. Organic phase was extracted 3 times with dichloromethane, dried over MgSO₄, filtrated, and concentrated under reduce pressure.

Theorical polymerization degree is

$$n = \frac{Y}{X} .$$

Molecular weight is calculated following the equation: Mnₑₓₚₑᵣᵢₘₑₙₜₐₗ=Mᵢₙᵢₜᵢₐₜₒᵣ+DPₑₓₚₑᵣᵢₘₑₙₜₐₗ×Mₘₒₙₒₘₑᵣ+Mₜₑᵣₘᵢₙₐᵢₛₒₙ.

Experimental polymerization degree is determined by NMR:
Protons corresponding to group CH₃=3H
Protons corresponding to initiator CH₂=2H

$$Number of repetition units = \{ \frac{3 * 2}{integration of C H 2 of initiator} ) / 3$$

Here the monomer oxetane was DMO (n equivalents), the initiator was benzylic alcohol (1 equivalent), the catalyst was BF₃Et₂O (1 equivalent) and the terminating agent was water.

The reaction is stopped after 10 min.

Following this procedure, the polymers disclosed in the table below have been prepared.

TABLE 8

| | | | | | Mn exp |
|---|---|---|---|---|---|
| n equivalent | Conversion | Yield | DPn th | DPn exp | (g/mol) |
| 9 | 99% | >90% | 9 | 8 | 820 |
| 15 | 99% | >90% | 15 | 15 | 1400 |
| 16 | 99% | >90% | 16 | 17 | 1600 |
| 27 | 99% | >90% | 27 | 26 | 2400 |
| 36 | 99% | >90% | 36 | 36 | 3200 |

Very good conversions and very good yields are obtained. The Mn expected and measured by NMR are in agreement. The end of the chain from the initiator is characteristic on the NMR spectrum thanks to the aromatic group.

Similarly, the following polymers have been synthetized.

### Monomers Screening

The general procedure disclosed above was followed. Here the nature of the monomer oxetane (15 equivalent) varied, the initiator was butan-1-ol (1 equivalent), the catalyst was BF3Et2O (1 equivalent) and the terminating agent was water. The reaction is stopped after 10 min. Following this procedure, the polymers disclosed in the table below have been prepared.

TABLE 9

| Monomer | Conversion | Yield | Mn th | Mn exp |
|---|---|---|---|---|
| DMO | 99% | >90% | 1400 | 1400 |
| BMMO | 99% | >90% | 2200 | 2000 |
| EMMO | 99% | >90% | 2100 | 1800 |
| EOMO | 99% | >90% | 2900 | 2700 |

The results obtained show total conversions to monomers (90-99%) and high yields (>90%) The chain ends from the butanol initiator are identified by NMR and allow the DPn to be estimated with precision. The final Mn are in agreement with the expected Mn.

### Degree of Polymerisation

The general procedure disclosed above was followed. Here monomer oxetane was EMMO (n equivalent), the initiator was butan-1-ol (1 equivalent, 1 mmol), the catalyst was BF₃Et₂O (1 equivalent, 1 mmol) and the terminating agent was water. The reaction is stopped after 10 min. Following this procedure, the polymers disclosed in the table below have been prepared.

TABLE 10

| n | | | | | Mnₑₓₚ |
|---|---|---|---|---|---|
| equivalent | Conversion | Yield | DPnₜₕ | DPnₑₓₚ | (g/mol) |
| 3 | 99% | >90% | 3 | 3 | 476 |
| 4 | 96% | 87% | 4 | 4 | 610 |
| 15 | 99% | >90% | 15 | 13 | 1800 |
| 25 | 99% | >90% | 25 | 25 | 3400 |
| 50 | 97% | 89% | 50 | 52 | 7000 |

NMR spectra make it possible to determine the chain size of the polymer using the chain end of the butanol initiator. For chain sizes>30 units, a 500 MHz spectrometer is used to properly view the end of the polymer chain from the initiator

In addition to having obtained a total conversion of the monomers (>95%) and very good yields (>85%), the PD calculated by NMR are in agreement with the expected PD. It is possible to selectively prepare the dimer, trimer or tetramer.

Screening of Initiator

The general procedure disclosed above was followed. Here monomer oxetane was EMMO (12 equivalents), the initiator varied (1 equivalent, 1 mmol), the catalyst was BF₃Et₂O (1 equivalent, 1 mmol) and the terminating agent was water. The reaction is stopped after 3 hours. Following this procedure, the polymers disclosed in the table below have been prepared.

TABLE 11

| | n | Con- | | | | Mnₑₓₚ |
|---|---|---|---|---|---|---|
| Initiator | _{equivalent} | version | yield | DPₜₕ | DPₑₓₚ | _{(g/mol)} |
| MeOH | 15 | 99% | >90% | 15 | 17 | 2200 |
| 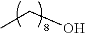 | 15 | 99% | >90% | 15 | 13 | 1800 |
| 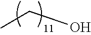 | 15 | 99% | >90% | 15 | 16 | 2200 |
| 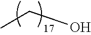 | 15 | 97% | 89% | 15 | 16 | 2200 |
| 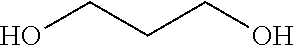 | 15 | 97% | >90% | 15 | 16 | 2200 |
| 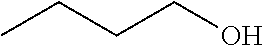 | 15 | 99% | >90% | 15 | 13 | 1800 |
| 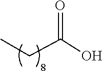 | 13 | 98% | >90% | 13 | 11 | 1600 |
| 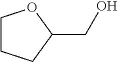 | 12 | 99% | >90% | 12 | 12 | 1700 |
| 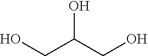 | 4 | 98% | >90% | 4 | 4 | 628 |

Initiating with different sizes of carbon chains makes it possible to provide hydrophobic properties without influencing the final yield of the polymer or the final Mn. The DPn is checked and the yields obtained are very good.

### Example 5—Copolymerisation with Initiator

In a 25 mL Schlenk tube purged under Argon, X mmol of initiator and X mmol of catalyst (1 eq./OH function) were introduced with 2 mL of solvent (dichloromethane). After 1 hour, Y mmol (n1 equivalent) of the first monomer oxetane solubilized in solvent (dichloromethane) were added. After 2 hours, Z mmol (n2 equivalent) of the second monomer oxetane were introduced. After 2 hours, reaction was stopped by adding termination agent. Organic phase was extracted 3 times with dichloromethane, dried over MgSO₄ filtrated, and concentrated under reduce pressure. Theorical DP of bloc monomer 1: Y/X and theorical DP of block monomer 2: Z/X. Mnₜₒₜₐₗ=Mᵢₙᵢₜᵢₐₜₒᵣ+DP₁×M_{monomer 1}+DP₂×M_{monomer 2}.

Here, 1 mmol of butan-1-ol was added to 1 mmol BF₃Et₂O, the termination agent is water.

TABLE 12

| n_{equivalent 1} | n_{equivalents 2} | Conversion | DPnₜₕ | DPnₑₓₚₗ | Mn_{exp (g/mol)} | Yield |
|---|---|---|---|---|---|---|
| 13 | 0 | 99% | 13 | 13 | 2000 | 97% |
| 12 | 1 | 96% | 12:1 | 11:1 | 2000 | 80% |
| 10 | 2 | 98% | 10:2 | 9:2 | 1700 | 82% |
| 8 | 5 | 99% | 8:5 | 8:5 | 1900 | 97% |
| 6 | 6 | 98% | 6:6 | 5:6 | 1600 | 92% |
| 4 | 8 | 98% | 4:8 | 4:8 | 1700 | 92% |
| 0 | 13 | 99% | 0:13 | 13 | 1800 | >90% |

The copolymer obtained is diblock. The variation in the percentage between each block of the copolymer has no impact on the conversion, the yield or the final DPn.

Increasing the percentage of the hydrophobic block does not affect the final yield. The copolymers obtained have DPn between 11 and 13 units (or Mn from 1700 to 2000 g/mol).

The percentage of each monomer can be calculated by NMR by integrating the CH₃ of the ethyl group of the EMMO monomer. Similarly, the length of the copolymer chain is calculated by integrating the end of the butanol initiator chain.

### Example 6—Sequential Copolymerisation with Initiator

To 1 mmol of propanediol is added 2 mmol of BF3Et2O. After 1 h at 21° C. under argon, “n” equivalents of the 1st monomer are added. After complete conversion, the chain is terminated by adding methanol. The polymer is purified and isolated. The NMR analysis reveals the end of the chain originating from the propanediol initiator, carrying a hydroxyalkyl function.

1 mmol of the homopolymer is added in the presence of 1 mmol of BF₃Et₂O. After 1 h at 21° C. under argon, “n” equivalents of the monomer are added. After complete conversion, the reaction is terminated by adding water. The final polymer is purified and isolated. NMR analysis reveals the disappearance of the hydroxyalkyl group. The chain growth on the end of the 1st homopolymer is effective. The DP of the second chain is calculated by making the integration difference between the total of the polymer and the 1st chain.

### Example 7—Polymerisation of EMMO with Sulfuric Acid as Catalyst without Solvent

In a 25 mL Schlenk tube purged with Argon, 1 molar equivalent of butan-1-ol and 1 molar equivalent of H₂SO₄ were introduced. After 1 hour, 21° C., 7 molar equivalent of monomer oxetane (EMMO) was added. After 3 hours, reaction was stopped by adding water. Organic phase was extracted 3 times with dichloromethane, dried over MgSO₄, filtrated, and concentrated under reduce pressure.

The homopolymer is obtained with a yield of 92%. The conversion is 93%. The polymer has a DPn of 7 and Mn of 1024 g/mol.

### Example 8—Antifoaming Tests

The general procedure disclosed in the examples above was followed and homopolymers, diblocks have been prepared.

50 ml of a 0.1 g/L Sodium lauryl ether sulfate (SLES) solution is introduced into a glass container. After magnetic stirring for 2 minutes, we note the appearance of 150 mL of foam. After adding 0.2% by mass of active material (antifoaming agent) and stirring, the volume of remaining foam is measured. The results are presented in the following table. The antifoam effect corresponds to the reduction of foam volume (in % by volume).

TABLE 13

| | Mn | | Antifoam |
|---|---|---|---|
| Antifoaming agent formula | (g/mol) | method | effect |
| 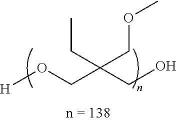 | 18000 | Homopolymerization without initiator | −70% |
| 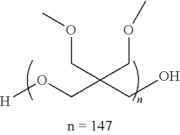 | 21500 | Homopolymerization without initiator | −70% |
| 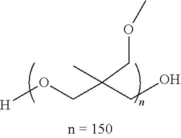 | 17500 | Homopolymerization without initiator | −60% |
| 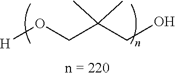 | 19000 | Homopolymerization without initiator | −80% |
| 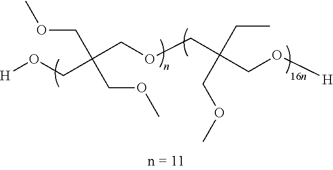 | 25600 | Copolymerization without initiator | −60% |
| 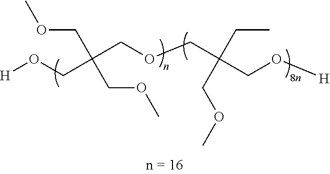 | 19250 | Copolymerization without initiator | −60% |
| 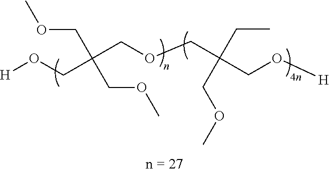 | 18400 | Copolymerization without initiator | −50% |
| 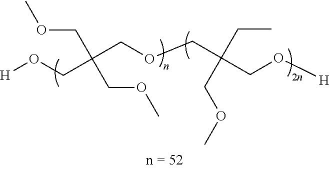 | 26600 | Copolymerization without initiator | −60% |
| 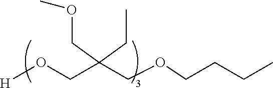 | 476 | Homopolymerization with initiator | −50% |
| 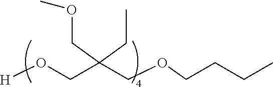 | 610 | Homopolymerization with initiator | −60% |
| 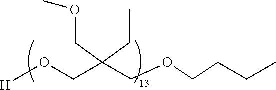 | 1800 | Homopolymerization with initiator | −60% |
| 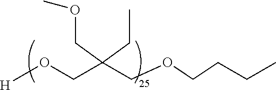 | 3400 | Homopolymerization with initiator | −60% |
| 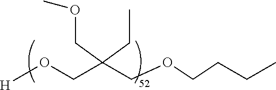 | 7000 | Homopolymerization with initiator | −50% |
| 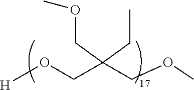 | 2200 | Homopolymerization with initiator | −40% |
| 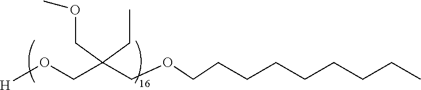 | 2200 | Homopolymerization with initiator | −70% |
| 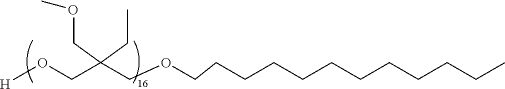 | 2200 | Homopolymerization with initiator | −70% |
| 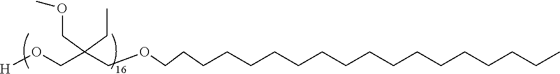 | 2200 | Homopolymerization with initiator | −50% |
| 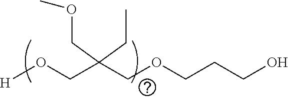 | 1800 | Homopolymerization with initiator | −60% |
| 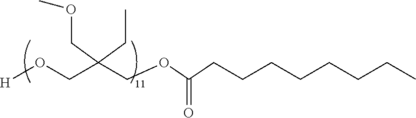 | 1600 | Homopolymerization with initiator | −80% |
| 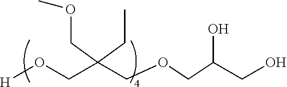 | 628 | Homopolymerization with initiator | −60% |
| 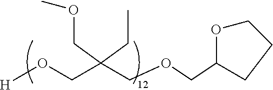 | 1700 | Homopolymerization with initiator | −60% |
| 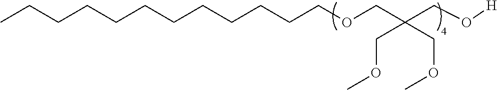 | 810 | Homopolymerization with initiator | −50% |
| 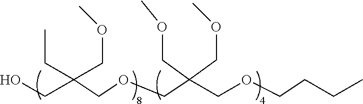 | 1700 | Copolymerization with initiator | −80% |
| 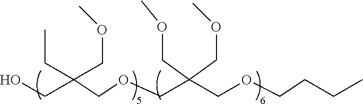 | 1600 | Copolymerization with initiator | −70% |
| 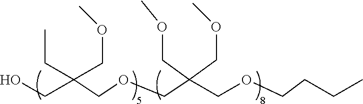 | 1900 | Copolymerization with initiator | −80% |
| 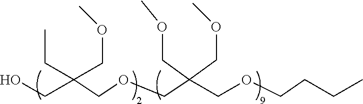 | 1700 | Copolymerization with initiator | −60% |
| 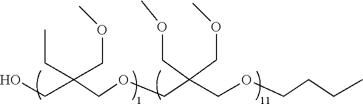 | 2000 | Copolymerization with initiator | −80% |
| 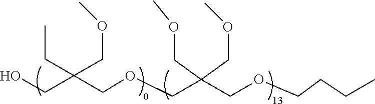 | 2000 | Copolymerization with initiator | −85% |

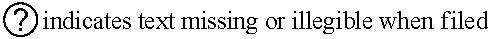

Homopolymers have an anti-foaming character of −70% on average.

The amphiphilic copolymers all have an anti-foaming character of approximately −60%.

1. A method for defoaming and/or preventing foam formation in a medium wherein a polymer P as antifoaming agent is added to the medium, the polymer P being a linear polymer prepared by polymerization of monomer chosen from monomer M1, monomer M2, or monomer M1 and monomer M2 monomer M1 having the following formula (I): 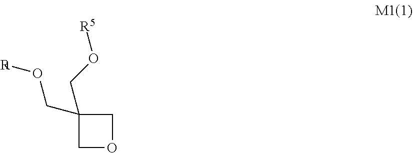
wherein
R¹ and R², independently of each other, is chosen from
a benzyl,
a (C₁-C₁₂)alkyl group optionally substituted by a —O—(C₁-C₁₂)alkyl group, and
a (C₃-C₁₂)cycloalkyl group optionally substituted by a —O—(C₁-C₁₂)alkyl group, monomer M2 having the following formula (II): 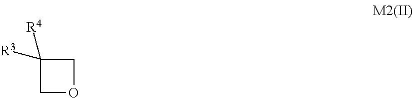
wherein
R⁴ represents
a (C₁-C₁₂)alkyl group or
a —CH₂—O—R⁵ group, wherein R⁵ is chosen from
a benzyl,
a (C₁-C₁₂)alkyl group optionally substituted by a —O(C₁-C₁₂)alkyl, and
a (C₃-C₁₂)cycloalkyl group optionally substituted by a —O—(C₁-C₁₂)alkyl group,
R³ represents a (C₁-C₁₂)alkyl group,
or R³ and R⁴ form together, with the carbon atom bearing them, a (C₃-C₁₂)cycloalkyl group.

2. The method according to claim 1, wherein R¹ and R², independently of each other, represent a (C₁-C₁₂)alkyl group optionally substituted by a —O—(C₁-C₁₂)alkyl group.

3. The method according to claim 1, wherein monomer M2 is a monomer of formula M2′ as follows: 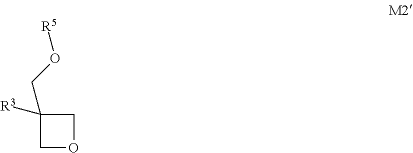
wherein
R⁵ is chosen from
a benzyl,
a (C₁-C₁₂)alkyl group optionally substituted by a —O(C₁-C₁₂)alkyl, and
a (C₃-C₁₂)cycloalkyl group optionally substituted by a —O—(C₁-C₁₂)alkyl group,
R³ is as described in claim 1.

4. The method according to claim 1, wherein R⁴ represents a group —CH₂—O—R⁵ and R¹, R², R³ and R⁵ represent, independently of each other, a (C₁-C₄)alkyl group.

5. The method according to claim 1, wherein polymer P is chosen from a statistic copolymer, a diblock copolymer with a structure B1-B2, a diblock copolymer with a structure B2-B1, a triblock copolymer with a structure B1-B2-B1 and a triblock copolymer with a structure B2-B1-B2, block B1 being prepared by polymerization of monomer M1 and block B2 being prepared by polymerization of monomer M2.

6. The method according to claim 1, wherein the polymer P has a number average molar mass Mn comprised from 400 g/mol to 30 000 g/mol.

7. The method according to claim 1, wherein the polymer P has a degree of polymerization DP comprised from 2 to 220.

8. The method according to claim 1, wherein the polymer P has a polydispersity index PDI comprised from 1 to 3.

9. The method according to claim 1, wherein the polymer P has a general formula (III)
R^{x}—O-[CU]-R^{y} (III)
wherein notation [CU] represents the constitutive units obtained by polymerization of monomer chosen from monomer M1, monomer M2, or monomer M1 and monomer M2, [CU] can further comprise at least one (C₁-C₁₂)alkylene group, —R^{DG}—, linking two constitutive units,
R^{x} is chosen from
a hydrogen atom,
a —CO—(C₁-C₂₀)alkyl group optionally substituted by at least one group —R^{z},
wherein R^{z} is chosen from
a hydroxyl group (OH),
a —O—(C₁-C₁₂)alkyl group,
an aliphatic 5- or 6-membered heterocycle, and
an aliphatic 5- or 6-membered carbocycle
a phenyl,
a benzyl,
a (C₁-C₂₀)alkyl group optionally substituted by at least one group —R^{z},
wherein R^{z} is as defined above.
R^{y} is chosen from:
a hydrogen atom,
a —CO—(C₁-C₂₀)alkyl group optionally substituted by at least one group R^{v} and
a (C₁-C₂₀)alkyl group optionally substituted by at least one group R^{v}, wherein
R^{v} is chosen from
a hydroxyl group (OH),
a —O—(C₁-C₁₂)alkyl group,
a phenyl,
a benzyl,
an aliphatic 5- or 6-membered heterocycle and
an aliphatic 5- or 6-membered carbocycle,
a halogen atom chosen from Cl, Br and F,
—SO₃H
—NH₂ or —NH—(C₁-C₆)alkyl group.

10. The method according to claim 9, wherein R^{x} and R^{y} are each a hydrogen atom.

11. The method according to claim 9, wherein R^{x} is chosen from
a —CO—(C₁-C₂₀)alkyl group optionally substituted by at least one group —R^{z},
wherein R^{z} is as defined in claim 9, and
a (C₁-C₂₀)alkyl group optionally substituted by at least one group —R^{z},
wherein R^{z} is as defined in claim 9.

12. An antifoam composition, under the form of an emulsion, comprising a polymer P as described in claim 1.

13. The antifoam composition according to claim 12, comprising in wt. % compared to the total weight of the antifoam composition:
from 0.01 to 100 of the polymer P,
from 0 to 99.99 of a substance chosen among stabilator, emulsifier, antioxidant agent, preservative, thickener, and mixture thereof,
the remaining, if any, being water.

14. A polymer prepared by copolymerization of monomer M1 and monomer M2, M1 and M2 being as defined in claim 1 wherein the number average molar mass Mn of polymer P′ is comprised from 400 g/mol to 30 000 g/mol and polymer P′ is not prepared by copolymerization of monomer M1, monomer M2 and THF.

15. The polymer P′ according to claim 14 manufactured according to a process comprising the steps of:
(a1) mixing a catalyst and an initiator chosen from an initiator of formula R^{x}OH, wherein R^{x} is as defined in claim 9, or an oxetane,
(b1+c1) adding to the mixture obtained after step (a1) a monomer chosen from monomer M1, monomer M2 and combinations thereof,
(d) then, adding a terminating agent.

16. The method according to claim 8, wherein the polymer P has a polydispersity index PDI comprised from 1.0 to 1.5.
